(19) United States
(12) Patent Application Publication
(10) Pub. No.: US 2002/0087867 A1
(43) Pub. Date: Jul. 4, 2002

(54) RF ID card

(76) Inventors: Robert R. Oberle, East Winsor, NJ (US); Chris Walker, Overland Park, KS (US)

Correspondence Address: Joseph P. O'Malley, Esq., BURNS, DOANE, SWECKER & MATHIS, L.L.P., P.O. Box 1404, Alexandria, VA, 22313-1404, US

(21) Appl. No.: 09/997,232

(22) Filed: Nov. 28, 2001

Related U.S. Application Data
(60) Provisional application No. 60/253,304, filed on Nov. 28, 2000.

(51) Int. Cl. H04K 1/00

(52) U.S. Cl. 713/183

(57) ABSTRACT

The present invention describes a system wherein an RF ID card uses a user interface, such as a keypad, to input a password. The password is encrypted and sent to an RF ID reader. Since the password is not permanently stored on the RF ID card, someone stealing the RF ID card cannot use the RF ID card to impersonate a user.

### RELATED APPLICATIONS

This application claims priority of U.S. Provisional Application No. 60/253,304, filed Nov. 28, 2000.

### FIELD OF THE INVENTION

The present invention relates to Radio Frequency Identification (RF ID) cards using digital encryption encoding.

### BACKGROUND OF THE INVENTION

RF ID systems are radio communication systems that communicate between an interrogator (RF ID reader) and a number of RF ID tags. Radio Frequency Identification (RF ID) tags are used for identification and tracking of equipment inventory or of living things. In some embodiments, the RF ID tags modulate a continuous-wave radio signal sent by the interrogator.

U.S. Pat. No. 6,130,623 describes an RF ID system which uses encryption of a Personal Identification Number (PIN) stored on the RF ID tag. A downside of the system of U.S. Pat. No. 6,130,623 is that since the PIN is stored at the RF ID tag, if the RF ID tag is stolen, the interrogator has no way of knowing that the RF ID tag is not in the hands of the correct owner.

It is desired to have an improved RF ID system which allows for improved security.

### SUMMARY OF THE INVENTION

One embodiment of the present invention is an RF ID unit using a user interface, such as a keypad. The user interface allows a user to input a password to the RF ID card. The password is encrypted into a message response to an RF ID reader. The RF ID reader decrypts the encrypted message and examines the password to authenticate the RF ID unit.

By having a user interface, such as a keypad, on the RF ID card, the RF ID card cannot be stolen and used by another person, because the user is required to input the password using the user interface before the system will work. The system of the present invention can be used for authenticating a user, for use in a commerce system, or a security system, such as a door access system.

### BRIEF DESCRIPTION OF THE DRAWING FIGURES

FIG. 1 is a diagram of a system of one embodiment of the present invention.

FIG. 2 is a diagram of an RF ID card of one embodiment of the present invention.

FIG. 3 is a diagram that illustrates the ID encoding of one embodiment of the system of the present invention.

FIG. 4. is a diagram that illustrates the operations of one embodiment of the system of the present invention.

### DETAILED DESCRIPTION OF THE INVENTION

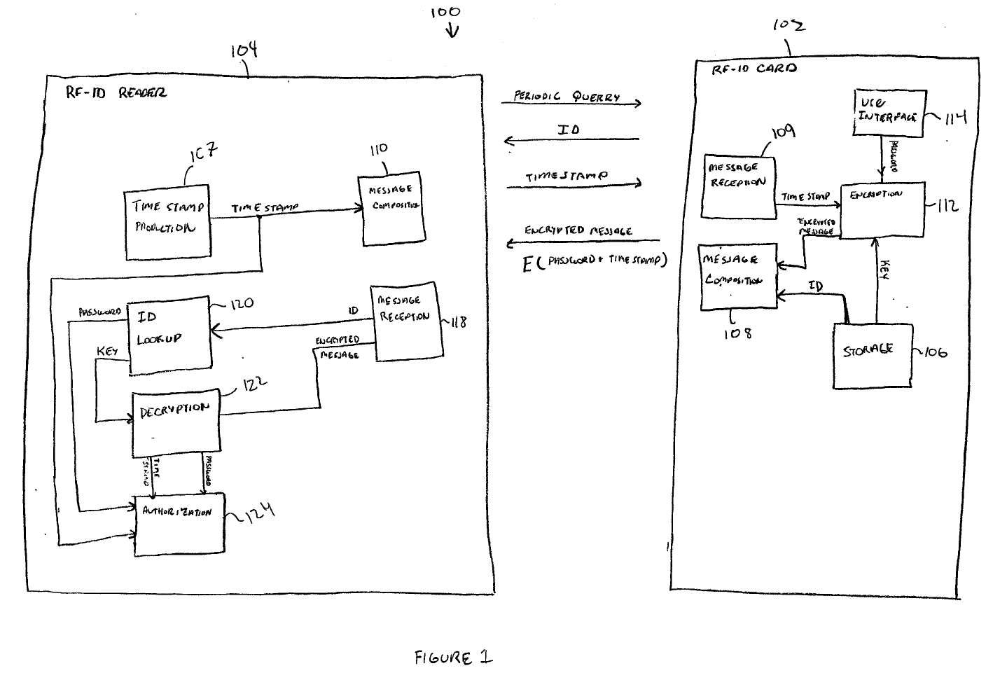

FIG. 1 illustrates an example of the system 100 in one embodiment of the present invention. System 100 includes an RF ID card 102 and an RF ID reader 104. Functions of the RF ID reader 104 as described below can also be done in an external network (not shown). In the system of FIG. 1, the RF ID reader periodically queries the RF ID card 102. In a preferred embodiment, the RF ID card responds with an ID. The ID is stored in storage 106 of the RF ID card 102. A message composition unit 108 receives the ID and composes the message including the ID, responding back to the RF ID reader 104. The RF ID reader 104 includes a timestamp production unit 107 which produces a timestamp which is provided to the message composition unit 110. The time-stamp signal is transmitted from the RF ID reader 104 to the RF ID card 102. In an alternate embodiment, the time stamp is part of the original query, and the ID along with the encrypted message can be sent at the same time.

The timestamp is received by the RF ID card 102. In a preferred embodiment, the message reception unit 109 provides the time stamp to the encryption unit 112 in the RF ID card 102. The encryption unit 112 also receives a key value from storage 106. In a preferred embodiment, the encryption unit uses the key to encrypt the timestamp along with a password received from the user interface 114. Since the password is preferably not stored on the RF ID card permanently, the RF ID card 102 cannot be stolen and used by an unauthorized user. For this reason, the RF ID card 102 in the preferred embodiment can be used like a credit card. The encrypted message including the encryption of the password and the key is provided to the message composition unit 108 and transmitted from the RF ID card 102 to the RF ID reader 104.

The RF ID reader 104 receives the encrypted message in the message reception unit 118. The previous message with the ID is used by an ID look-up unit 120 to obtain the password and key from an external network. The key obtained at the RF ID reader 104 and the RF ID card 102 can be the same for a system in which each RF ID card has a single key. Alternately, public/private encryption system is used in which the key at the RF ID card 102 is a private key while the key at the RF ID reader 104 is a public key or vice versa. In some embodiments, the ID look-up functions 120 are implemented at the external network. The use of a public/private key system has the advantage that the disclosure of the public key at the RF ID reader or external network will not lessen the security of the system. The decryption operation 122 receives the encrypted message and uses the key from the ID look-up to decrypt the message. The decrypted message includes the password and the time stamp. Authorization unit 124 examines the password obtained by the ID look-up and the current time stamp in order to determine an authorization. In one embodiment, the time stamp can be checked to be within a certain time range. In another embodiment, instead of a time-stamp, another number could be provided that does not relate to time information. For example, a random number can be used.

The blocks shown in the RF ID reader 104 and RF ID card 102 in one embodiment are implemented in software. The transmission between the RF ID card and the RF ID reader can be any of the conventional RF ID transmissions. In one embodiment, the energy provided by the queries from the RF ID reader 104 provides the energy for the RF ID card 102 to operate.

In an alternate embodiment, the RF ID card 102 stores a password in memory and the stored password can be used. If this embodiment is used, it is preferable that the password be periodically flushed from the RF ID card to require that the user input the password again.

Since in a preferred embodiment the encrypted message includes both the encrypted password and the timestamp, there is a limited amount of time that the data obtained from a snooping device is valid. The time-stamp cannot be obtained from monitoring the RF transmissions without decrypting the encrypted message.

In an alternate embodiment, the time-stamp is not used. However, in this alternate embodiment, even though the password is encrypted and a snooper cannot obtain the password information, it would not understand the encrypted message information and thus be able to spoof RF ID readers until the encryption key is changed.

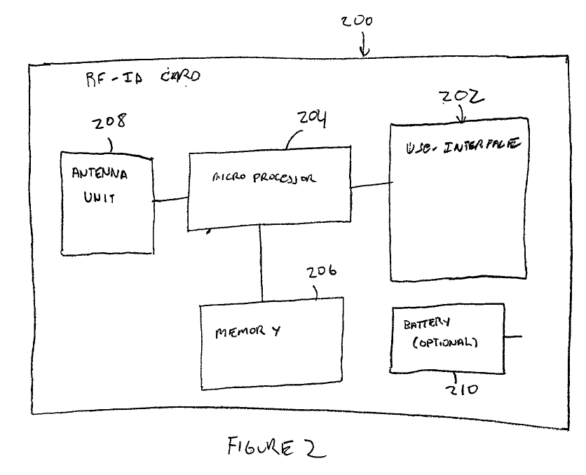

FIG. 2 illustrates an RF ID card 200 of one embodiment of the present invention. In this embodiment, the RF ID card includes the user interface 202. In one embodiment, the user interface comprises a keypad. In one embodiment, the user interface 202 uses a number of membrane switches. One example of such a system is the keypad entry system seen on Ford Motor Corporation vehicles. Alternately, the user interface is some other element that allows input by the user.

In an alternate embodiment, the user interface is on another device that is attachable to the RF ID card, rather than on the RF ID card itself. For example, in one embodiment, the password is input from a PDA or other device to the RF ID card. In one embodiment, the RF ID card stores the input password in a memory; the password is then reprogrammable by the another device. In one embodiment, the RF ID card uses a PC card connector to connect to the another device.

In one embodiment, a microprocessor 204 associated with the memory 206 runs the algorithms of the RF ID card. The microprocessor is associated with an antenna unit 208 for transmitting and receiving the messages. The microprocessor receives the query and obtains the ID from the memory 206 to transmit across the antenna unit 208. The unit receives the time-stamp across the antenna 208 and then combines the time-stamp with the password obtained from the user interface 202, and encrypts it using a key stored in the memory 206. The encrypted message is then transmitted using antenna unit 208.

Battery 210 is optional. In one embodiment, the energy provided by the RF ID reader provides energy for operation of the microprocessor. In a further embodiment, a capacitor (not shown) is used to store energy transmitted by the RF ID reader.

FIG. 3 illustrates an example of the RF ID card encoding. In this example, the transaction partner is selected. Optionally, the RF ID tag is encoded with the proper key or keys. A query from the encoder is sent to the RF ID tag unit. The RF ID tag unit responds to the query and the RF ID encoder confirms the key transfer. The keys are then stored in the memory of the RF ID card. If a conventional hidden key system is used, the key stored in the RF ID tag matches the key stored at the external network and the RF ID reader. Alternately, the public key and private key can be produced by the external network, the private key provided to the RF ID card unit and the public key stored in the external network. The private key can then be erased from the external network. Alternately, in some embodiments, the public key is stored in the RF ID card and the private key is stored in the external network.

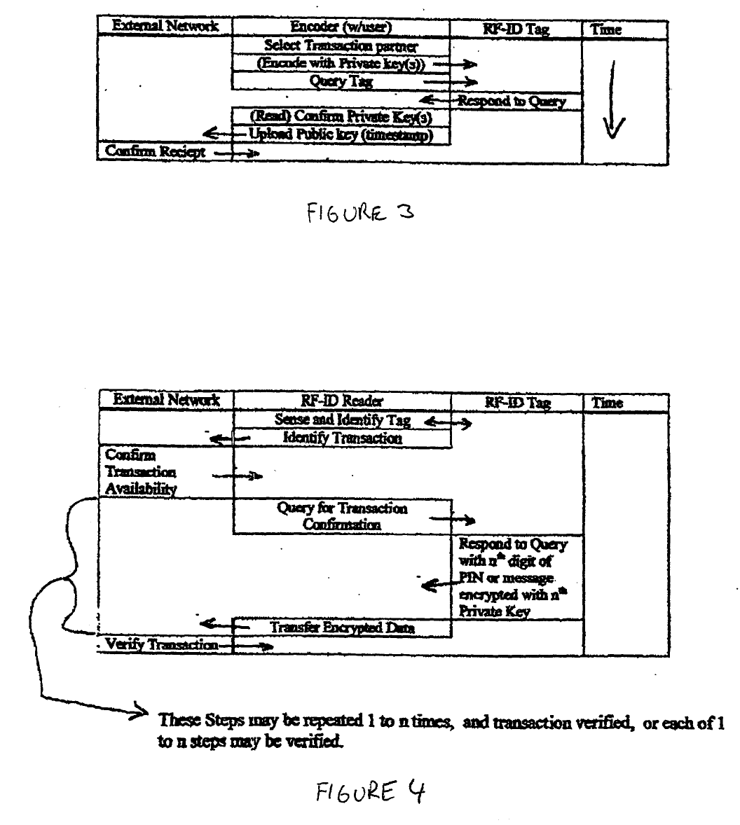

FIG. 4 illustrates an alternate embodiment the system of the present invention. In this embodiment, the RF ID tag senses and identifies itself using an ID. The transaction is identified to the external network. The external network then responds by confirming the transaction availability. The RF ID reader queries for the transaction confirmation. The RF ID card responds to the query with the nth digit of the PIN or message encrypted with the nth private key. The encrypted information is provided to the external network, which does the decryption and verifies the transaction.

In one embodiment, the purpose of the proposed invention is to provide for secure transactions between a RF ID tag and a fixed network. The fixed network is comprised of a reader and an associated information system. In this embodiment, the RF ID tag is a transponder that returns a signal in response to a RF query from a reader. The tag is a mobile device, either battery powered or directly powered by the RF field of the reader. Embodiments may be a credit-card-size device in a wallet, a label affixed to a pallet or package, or alternatively, a fixed device which is activated by a passing hand-held or portable detector system. The tag may also have other features incorporated, such as an onboard user interface or a pre-programmed expiration date.

In one embodiment, secure communication can be established by an encryption scheme. In a public/private key scheme, each RF ID card carries with it a private key that pairs with a known public key. In a further embodiment, the public key is published openly and/or selectively uploaded onto information networks that the authorized card user chooses and as he is allowed. Alternately, the individual public/private key pair is stored in an onboard EPROM that is programmed either permanently or temporarily by the tag user. When the user programs the card, the tag's public key is sent to the other party. In this manner, the pair can communicate through the receiver's network; however, another network, which has not received the tag's public key, cannot identify the tag or the tag user.

In one embodiment, the public key carries a time-stamp which expires, thus allowing the card carrier to control not only the authorized networks, but also the period to which they are authorized. When the tag user decides that he no longer wishes to be part of the user network, he simply reprograms or discards the tag and encodes a new one for whatever purposes he wishes.

In one embodiment, in order to make purchasing secure, the card design and chipset incorporates a set of membrane switches. These membrane switches would attach to the chip and allow the authorized user to enter a PIN at the point of purchase or other transaction point. The switch system could be analogous to the keypad entry systems seen on Ford Motor Corporation vehicles.

In one example, a purchaser picks up an item at a kiosk and intends to make a purchase. The fixed network reads the information on the item to be purchased, either by RF ID or other identification method. The purchaser then presents his RF ID credit card to the kiosk reader. The reader identifies the card, if it is previously authorized to do so, and requests verification. The cardholder depresses the membrane switches on the card in the correct sequence and the real-time validation is accomplished. The advantages of this method over swipe card transactions are realized when the number of objects purchased at the kiosk is large. For instance, a single validation can be made and the keypad that would be required on a fixed network would be eliminated. Also, neighboring kiosks could share the same scanning network, but if one data network is enabled, and another is not, the possibility of faulty or unauthorized transactions is reduced.

The sequence of key strokes entered on the card is essentially a PIN, and the successful transaction requires the fixed network know the PIN for a particular card, as well as be in possession of a valid public key that corresponds to the private key.

In an alternate embodiment, the RF ID card responds to the network query with standard message or series of messages that is/are encoded with a series of private keys for which the public keys have been made known to the network. In this case, the network is required not only to know, or derive, each public key; and the sequence in which they are required to be used.

In another embodiment, for transactions between a selectively enabled network, the RF ID smart card can be a hybrid RF ID and contact smart card. This could be fitted into an expansion slot in a mobile phone or PDA. The RF ID card could selectively identify itself to “bluetooth” type networks as the user moves through a mall or factory. In this case, real-time information could be exchanged with the PDA and the bluetooth network on a selective and easily resettable basis. The information transfer is preferably under the control of the user to protect the user from unwanted tracking or spamming.

In one embodiment, the RF-ID card identifies itself once to a selected network. That identification is subject to a timestamp. For the period of time that the timestamp is valid, the RF-ID card is open to identification by the network. Afterwards, it is not.

The transmitted frequencies can be used in any of the frequency ranges allowed by a country's authorizing agency, such as the FCC. In one embodiment, the 13.56 MHz range is used which is preferable to the 900 MHz range.

Additionally, the user interface in one embodiment uses a thermal device or any other type of input.

It will be appreciated by those of ordinary skill in the art that the invention can be implemented in other specific forms without departing from the spirit or character thereof. The presently disclosed embodiments are therefore considered in all respects to be illustrative and not restrictive. The scope of the invention is illustrated by the appended claims rather than the foregoing description, and all changes that come within the meaning and range of equivalents thereof are intended to be embraced herein.

What is claimed is:

1. A System comprising:
an RF ID unit; and
an RF ID reader, wherein the RF ID unit is adapted to transmit a stored ID to the RF ID reader, the RF ID unit adapted to encrypt a password input from a user interface to form an encrypted message, the RF ID unit adapted to transmit the encrypted message to the RF ID reader, the RF ID reader adapted to use the ID to obtain a key to decrypt the encrypted message with the key and to authenticate the RF ID unit.

2. The system of claim 1, wherein the user interface is on the RF ID unit.

3. The system of claim 1, wherein user interface is on another device that is attachable to the RF ID unit.

4. The system of claim 1 wherein the RF ID reader transmits additional data to the RF ID unit, the transmitted message including an encrypted password and the additional information.

5. The system of claim 4 wherein the additional information is a timestamp.

6. The system of claim 1 wherein the RF ID reader and the RF ID unit use the same key.

7. The system of claim 1 wherein the RF ID reader and the RF ID unit use a different key.

8. The system of claim 7 wherein the RF ID reader and the RF ID unit encrypt and decrypt using a public/private encryption algorithm.

9. The system of claim 1 wherein the ID is used to look up key and password.

10. The system of claim 1 wherein the RF reader is associated with an external network, the RF ID reader sending the ID to the external network to obtain the key, and the RF ID reader sending the encrypted message to the external network.

11. The system of claim 1 wherein the system is used to authenticate a user.

12. The system of claim 1 wherein the system is used to provide a secure passage of a user within a building.

13. The system of claim 1 wherein the system is used for authentication.

14. The system of claim 13 wherein the system is used for commercial transaction authentication.

15. The system of claim 1 wherein the user interface is a keypad.

16. A method comprising:
transmitting an ID from an RF ID unit to an RF-ID reader;
receiving a password from a user interface;
encrypting the password to form an encrypted message; and
transmitting the encrypted message from the RF ID unit to an RF-ID reader.

17. The method of claim 16 wherein the user interface is on the RF ID card.

18. The method of claim 16 wherein the user interface is on another device attachable to the RF ID card.

19. The method of claim 16 wherein additional data is provided from the RF ID reader to the RF ID unit, the RF ID unit encrypting the password along with the additional data to form the encrypted message.

20. The method of claim 16 wherein the additional data is a time-stamp.

21. The method of claim 16, further comprising decrypting the encrypted message.

22. The method of claim 16 wherein the encryption method is a public/private encryption method.

23. The method of claim 16 wherein the encryption is a hidden key encryption system.

24. The method of claim 16 wherein the user interface is a keypad.

25. An RF ID unit with a user interface, the RF ID unit adapted to transmit a stored ID to a RF ID reader, the RF ID unit adapted to encrypt a password input from the user interface to form an encrypted message, the RF ID unit adapted to transmit the encrypted message to a RF ID reader.

26. The RF ID unit of claim 25 wherein the RF ID unit receives additional data from the RF ID reader, the additional data being encrypted along with the password to form the encrypted message.

27. The RF ID unit of claim 27 wherein the additional data is a time-stamp.

28. The RF ID unit of claim 25 wherein the encryption is a public-key/private-key encryption system

29. The system of claim 25 wherein the encryption is a hidden key encryption system.

30. The system of claim 25 wherein the user interface is a keypad.
